(19) United States
(12) Patent Application Publication
(10) Pub. No.: US 2025/0274575 A1
(43) Pub. Date: Aug. 28, 2025

(54) LIGHT FIELD PRE-CONDITIONING FOR A MULTI-VIEW DISPLAY

(71) Applicant: Avalon Holographics Inc., St. John’s (CA)

(72) Inventor: Kyle Willick, Goulds (CA)

(21) Appl. No.: 18/585,864

(22) Filed: Feb. 23, 2024

(51) Int. Cl. H04N 13/351; G02B 30/10; G03H 1/00; H04N 13/32; H04N 13/327

(52) U.S. Cl. CPC H04N 13/351; G02B 30/10; G03H 1/0005; H04N 13/32; H04N 13/327

(57) ABSTRACT

A method to enhance the quality of light field images for multi-view displays through light field pre-conditioning. A hogel-based approach uses measurement of pixel luminosity at a canonical pixel in a hogel to guide image pre-processing. By determining a pre-conditioned input light field for pixels in the light field display, the resulting output light field closely approximates the desired ideal output, providing a sharper and smoother image.

### FIELD OF THE INVENTION

The present disclosure relates to a method to enhance the quality of light field image in multi-view displays, such as holographic displays. More specifically, the present disclosure relates to a method of light field measurement and pre-conditioning for a multi-view display comprising a plurality of optical elements.

### BACKGROUND OF THE INVENTION

Current 2D display technology provides a single image output, or output image, to all viewers. In a 2D display all viewers see the same image in both eyes based on their location relative to the display, such that all pixels in the display can be seen at once by a viewer. Because only a single image is displayed, both the eyes of the user capture the same image, rendering it substantially absent of any perceivable depth. In contrast, 3D displays provide two different images to the viewer, one image for each eye of the viewer, to allow depth perception. [0003]3D image displays can be generally divided into two broad types: binocular stereoscopic and autostereoscopic. Binocular stereoscopic displays use special eyewear to facilitate the viewing of two slightly different images in each of the left and right eye, whereas autostereoscopic displays permit the viewer to see, with the naked eye, two different images, one in each eye. Each of the two different images received by the viewer relies upon the distance between the eyes such that each eye is effectively at a different viewing position relative to the display, and therefore receives a different image. When each eye receives a slightly different image, as people do when interacting with a 3D world, the two images together create depth cues and a realistic 3D visual experience.

To achieve the display of many different images at the same time, autostereoscopic displays are generally one of two types, eye-tracking displays or multi-view displays.

Autostereoscopic displays, based on eye tracking, collect the user position relative to the display to calculate what image the display should output, allowing for a selective image output. This type of autostereoscopic display therefore requires a means to track the eye location and movement of the viewer of the display, which can be achieved using viewer head-mounted gear, such as glasses or head-mounted detectors or cameras, or alternatively external detectors or frontal cameras installed in and/or around the display. The viewer position information can be provided to the display such that the display projects only images in the location of visual perception of the user. Multi-view autostereoscopic displays, also referred to as multi-view displays, do not selectively output each view specific image, but instead are agnostic as to the position of the viewer and simultaneously display all of the viewable images for each viewing angle regardless of whether there is a viewer receiving the image. A multi-view display enables users to easily and seamlessly move around relative to the display as well as to simultaneously display holographic 3D images to many viewers without requiring a determination of the position of each user.

Due to the computational and energy requirement intensity of multi-view displays, early multi-view autostereoscopic displays were only able to output a few different images at a time, also referred to as views. However, modern multi-view light field displays are capable of simultaneously outputting a much larger number of images at a time with sufficient image density to enable a 3D viewing experience. Reproducing enough light rays from a 3D scene to create a multi-view light field display demands precise light emission from a light emission system having a precise directional light emission at a plurality of closely spaced viewing angles.

Light field display devices can provide a specified directionality to each light ray using an array of pixels and hogel groupings of subpixels. In a light field display with tens of millions to tens of billions of pixels, creating a uniform and seamless image is a significantly challenging task. In both projector-based light field display systems and flat panel (i.e., LED, OLED, LCD, and MicroLED) display devices, physical effects such as diffraction and practical alignment tolerances can cause tiling, distortion, and blurring, reducing the overall image quality. Further, misalignment and differences in brightness and directionality of each subpixel in an flat panel display device or slight deviations in the configuration or properties of projector components in projector bases light field display systems may arise due to manufacturing variations of each emitting optical element. Pre-conditioning of images, or adjustment of pixel brightness, color, sharpness, blur, and smoothness, can significantly increase the image quality and therefore the viewing experience.

In one example of image conditioning in a two-dimensional display, Brown et al. (M. S.

Brown, Peng Song and Tat-Jen Cham, “Image Pre-Conditioning for Out-of-Focus Projector Blur,” 2006 IEEE Computer Society Conference on Computer Vision and Pattern Recognition (CVPR '06), New York, NY, USA, 2006, pp. 1956-1963, doi: 10.1109/CVPR.2006.145.) describe an image pre-conditioning method for 2D image sharpening based on measured output image measurement. The image blur in the output image is obtained by measuring the output of each of the pixels in the display. In another example, Zhou et al. (M. Zhou et al., “A Unified Method for Crosstalk Reduction in Multiview Displays,” in Journal of Display Technology, vol. 10, no. 6, pp. 500-507, June 2014, doi: 10.1109/JDT.2014.2305995.) describe as method for crosstalk reduction in multiview displays by reducing overlap of pixels. In particular, extrinsic crosstalk resulting from fabrication or assembling errors and intrinsic crosstalk originating from leaked light from close neighboring views is addressed by adjusting the predefined view index (i.e., the corresponding viewpoint number) and grayscale intensity of each subpixel in a liquid crystal display (LCD). Although the display described in Zhou et al. is a multi-view one, the number of views is limited to only 9 images, and all the different views are visible at a single view angle.

In another method of image enhancement in a 3D display, United States patent U.S. Pat. No. 10,523,928B2 to Hwang et al. describes a distortion correction method comprising displaying a first image on a display panel based on source images that correspond to respective viewpoints of the display panel, generating a second image by capturing the display panel at a first point, and determining a first compensation value to be used to compensate for a distortion of the second image with respect to the display panel.

In light field display technology, for both flat panel (i.e., LED, OLED, LCD, and MicroLED) and projector-based displays, blurring of pixels can result from imperfections in optical components or diffraction due to finite aperture requirements, for example of tightly packing projectors or hogels. In an idealized light field display, the light from an individual pixel is output as a narrow symmetric beam around the direction of ray travel. Adjusting for misalignment of the travel direction of the light from the pixel relative to the ideal ray direction can be done in a projector-based system by adjusting a projector angle or using optical components such as lenses. Uneven distribution, or blur, is more challenging to correct with a hardware-based correction. After manufacture, there is a limit on the degree to which these optical deviations can be fixed with hardware. Software solutions, such as light field pre-conditioning, can address pixel blurring to provide a sharper displayed image. There remains a need for a method of light field pre-conditioning for obtaining high quality images in a high pixel density multi-view autostereoscopic light field display.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a pre-conditioning method for an input light field comprising: positioning a light sensor to receive light from a hogel in a light field display plane; displaying a pixel illumination pattern centered at a first pixel location in the hogel on the light field display plane; measuring a light intensity value at a canonical pixel in the hogel with the light sensor; displaying the pixel illumination pattern at an offset position relative to the first pixel location on the light field display plane; measuring the light intensity value at the canonical pixel when the pixel illumination pattern is at the offset position; generating a luminance profile for the canonical pixel based on the light received by the light sensor at the canonical pixel; and calculating a correction factor for the canonical pixel.

In an embodiment, the method further comprises displaying the pixel illumination pattern at a plurality of offset positions relative to the first pixel location and measuring the light intensity value at the canonical pixel at each of the plurality of offset positions.

In another embodiment, the method further comprises applying the correction factor to an input light field for at least one pixel in the hogel.

In another embodiment, the method further comprises recalculating the correction factor for each of a plurality of input light fields.

In another embodiment, the method further comprises applying the correction factor to the input light field for all pixels in the hogel.

In another embodiment, the correction factor adjusts the luminosity for at least one pixel in the hogel.

In another embodiment, the pixel illumination pattern is a single pixel, linear, stepped linear, square, stepped square, rectangle, cross, stepped cross, reticle, or target.

In another embodiment, the light intensity value at the canonical pixel is measured at multiple color channels.

In another embodiment, the correction factor is calculated for each color channel.

In another embodiment, the correction factor for each color channel is combined and applied to the input light field.

In another embodiment, the offset position relative to the first pixel location is along one or both of the x and y axis of the hogel.

In another embodiment, the method further comprises calculating a per-pixel blurring kernel based on the luminance profile.

In another embodiment, the light field display plane is created by a light field display comprising a directional pixel array in a projector-based light field display or a flat panel light field display. In another embodiment, the flat panel display is one of a LED, OLED, LCD, or MicroLED display.

In another embodiment, calculating a correction factor results in one or more of sharpening the light field and smoothing the light field.

In another embodiment, the light sensor measures the light intensity from more than one hogel in the light field display plane.

In another embodiment, the light intensity value measured at the light sensor measures multiple color channels at the same time.

In another embodiment, the method further comprises positioning an additional light sensor to receive light from an additional canonical pixel in the hogel in a light field display plane; displaying a pixel illumination pattern centered at an additional pixel location in the hogel on the light field display plane; measuring a light intensity value at an additional canonical pixel in the hogel with the light sensor; displaying the pixel illumination pattern at an additional offset position relative to the additional pixel location on the light field display plane; measuring the light intensity value at the additional canonical pixel when the pixel illumination pattern is at the additional offset position; and generating a luminance profile for the additional canonical pixel based on the light received by the additional light sensor at the additional canonical pixel.

In another embodiment, calculating the correction factor comprises incorporating into the correction factor an additional correction factor for the additional canonical pixel.

In another aspect there is provided a system for pre-conditioning a light field display comprising: a light sensor for measuring a light intensity value in the direction from a canonical pixel in a hogel in a display plane of a light field display; a frame for supporting the light sensor in front of the display plane; and a processor configured to perform the method of: displaying a pixel illumination pattern centered at a first pixel location in the hogel on the display plane; displaying the pixel illumination pattern at an offset position relative to the first pixel location on the display plane; generating a luminance profile from the light intensity values measured by the light sensor for the canonical pixel at the first pixel location and the offset position, the luminance profile describing the light received from the direction of the canonical pixel to the light source from the display plane.

In an embodiment, the processor calculates a correction factor for the canonical pixel.

In another embodiment, the light field display comprises a directional pixel array in a projector-based light field display or a flat panel light field display. In another embodiment, the flat panel display is one of a LED, OLED, LCD, or MicroLED display.

In another embodiment, the processor is further configured to perform the steps of: calculating a correction factor for the canonical pixel; applying the correction factor to an input light field to generate a corrected light field; and displaying the corrected light field on the light field display.

In another embodiment, the light sensor is a single frequency light sensor, multi-frequency light sensor, photosensitive detector, charged coupled device (CCD), liquid crystal on silica (LCOS) sensor, or camera.

In another embodiment, the light sensor comprises one or more additional optical components for light shifting, lensing, collimating, or directing light.

In another embodiment, the offset position relative to the first pixel location is along one or both of the x and y axis of the hogel.

In another embodiment, the system comprises more than one light sensor.

Embodiments of the present invention as recited herein may be combined in any combination or permutation.

### BRIEF DESCRIPTION OF THE DRAWINGS

The drawings contained in this disclosure provide some possible embodiments of the present application. These and other features of the invention will become more apparent in the following detailed description in which reference is made to the appended drawings.

FIG. 1 illustrates a multi-view (x,y) projector-based display plane with a light sensor at a reference position.

FIG. 2 illustrates a single hogel in a display plane comprising multiple directional pixels.

FIG. 3 illustrates the illumination of three directional pixels in a hogel in a linear pixel illumination pattern.

FIG. 4A illustrates an example 3×3 stepped cross pixel illumination pattern around an origin pixel.

FIG. 4B illustrates an example 5×5 stepped cross pixel illumination pattern around an origin pixel.

FIG. 5 illustrates different example pixel illumination patterns.

FIG. 6 illustrates the displacement of a cross pixel illumination pattern around a canonical pixel in a hogel.

FIG. 7 is a graph of the luminance or brightness value data set for a single canonical pixel in a pixel array across a pixel illumination pattern sweep in the y axis.

FIG. 8 are graphs of light intensity for a canonical pixel based on the distance of the origin of a pixel illumination pattern for a plurality of canonical pixels in a display plane.

FIG. 9 is a flowchart illustrating a method of pixel input optimization for a light field display.

FIG. 10 is a flowchart illustrating a method of generating a pixel luminance.

FIG. 11 is a flowchart illustrating a method of characterization by optical measurement and pixel input optimization for a whole light field projector display.

FIG. 12 illustrates a subsection of a light field before and after sharpening compared to an ideal light field output.

FIG. 13 illustrates a setup for a projector-based multi-view display plane with two optical sensors at different reference positions.

FIG. 14 illustrates a projector-based multi-view display having tiled optical elements configured to provide light to each pixel in each hogel of the multi-view display.

FIG. 15 illustrates a multi-view (x,y) flat panel based display plane in a plane with a light sensor at a reference position.

### DETAILED DESCRIPTION OF THE INVENTION

Unless defined otherwise, all technical and scientific terms used herein have the same meaning as commonly understood by one of ordinary skill in the art to which this invention pertains.

The use of the word “a” or “an” when used herein in conjunction with the term “comprising” may mean “one,” but it is also consistent with the meaning of “one or more,” “at least one” and “one or more than one.”

As used herein, the terms “comprising,” “having,” “including” and “containing,” and grammatical variations thereof, are inclusive or open-ended and do not exclude additional, unrecited elements and/or method steps. A composition, device, article, system, use or method described herein as comprising certain elements and/or steps may also, in certain embodiments consist essentially of those elements and/or steps, and in other embodiments consist of those elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to. The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment” and “for example” is intended to illustrate or denote aspects, embodiments, variations, elements or features relating to the invention and not intended to limit the scope of the invention.

As used herein, the terms “connect” and “connected” refer to any direct or indirect physical association between elements or features of the present disclosure. Accordingly, these terms may be understood to denote elements or features that are partly or completely contained within one another, attached, coupled, disposed on, joined together, in communication with, operatively associated with, etc., even if there are other elements or features intervening between the elements or features described as being connected.

As used herein, the term “OLED” refers to an Organic Light Emitting Diode, which is an opto-electronic device which emits light under the application of an external voltage. OLEDs have an emissive electroluminescent layer or organic material or species that emits light in response to an electric current. Without being bound by theory, when a current is applied, an anode injects holes and a cathode injects electrons into the organic layers of an OLED. The injected holes and electrons each migrate toward the oppositely charged electrode. When an electron and hole localize on the same molecule, an exciton, which is a localized electron-hole pair having an excited energy state, is formed. Light is emitted when the exciton relaxes via a photo emissive mechanism. Types of OLED include but are not limited to Active-matrix OLEDs (AMOLED) and Passive-matrix OLEDs (PMOLED). AMOLEDs have full layers of cathode, organic molecules, and anode. The anode layers have a thin film transistor (TFT) plane in parallel to it so as to form a matrix. This helps in switching each pixel to its on or off state as desired, thus forming an image. Hence, the pixels can be switched off whenever they are not required or there is a black image on the display, decreasing the energy required to illuminate the display. This is the least power consuming type of OLED and has quicker refresh rates which makes them suitable for video. PMOLEDs have a similar composition to AMOLEDs but the cathode lines are arranged at right angles to the anode lines. The electrical control is achieved through the anode and cathode lines to activate the pixel at the intersection point, generating light. The display background of a PMOLED is always black while the color displayed when the pixel is turned on is a predetermined color. PMOLED pixels are fixed to a single color and are not suitable for dynamic imagery or displays. OLEDs may be top or bottom emitting. Top-emitting OLEDs have a substrate that is either opaque or reflective. An OLED is bottom emitting if the emitted light passes through the transparent or semi-transparent bottom electrode and substrate. Top-emitting OLEDs are generally better suited for active-matrix applications as they can be more easily integrated with a non-transparent transistor backplane.

As used herein, the term “pixel” refers to a spatially discrete light emission mechanism used to create a display. As used herein, a pixel array refers to an array of directional pixels in a hogel.

As used herein, the term “light emitting diode” or “LED”, refers to a semiconductor device that emits light when an electric current passes through it. LEDs are constructed of layers of semiconductor materials that, when energized, release photons. These devices are highly efficient at converting electrical energy into light and are commonly used in various applications such as lighting, displays, indicators, and signage. LEDs offer advantages including durability, energy efficiency, and flexibility in color and intensity, making them prevalent in modern lighting solutions and electronic devices.

As used herein, the term “LCD”, or “Liquid Crystal Display” is a flat panel display technology that utilizes the properties of liquid crystals to produce images. In an LCD, liquid crystals are sandwiched between two layers of glass or polymer substrates. When an electric current is applied to the liquid crystals, they twist and align to control the passage of light through them. This manipulation of light allows LCDs to create images and display content.

LCDs are commonly used in electronic devices such as televisions, computer monitors, smartphones, and tablets due to their lightweight design, low power consumption, and ability to produce high-quality images with vibrant colors and sharp details.

As used herein, the term “MicroLED” refers to an emerging display technology that has a plurality of microscopic light-emitting diodes (LEDs) arranged in an array. Unlike traditional LED displays, which use large LEDs, MicroLED displays utilize tiny individual LEDs, typically on the scale of micrometers. Each MicroLED functions as a pixel, emitting its own light independently. MicroLED displays offer several advantages, including high brightness, high contrast ratios, wide color gamut, and fast response times. They also consume less power compared to traditional display technologies and have the potential for improved longevity. MicroLED technology is seen as a promising candidate for next-generation display applications, including large-scale TVs, augmented reality (AR) and virtual reality (VR) devices, wearable electronics, and automotive displays.

As used herein, the term “flat panel display” refers to a type of electronic visual display technology characterized by a slim, flat profile and a uniform display surface. These displays use various technologies such as liquid crystal displays (LCDs), plasma displays, organic light-emitting diodes (OLEDs), and microLEDs to produce images. Unlike older cathode ray tube (CRT) displays, flat panel displays do not rely on bulk_{y}, curved tubes for image projection. Instead, they utilize thin layers of materials or cells to generate images directly on a flat surface.

Flat panel displays are commonly found in devices such as televisions, computer monitors, laptops, tablets, smartphones, and digital signage. They offer advantages such as space efficiency, lightweight design, energy efficiency, and high-quality image reproduction, making them widely popular in consumer electronics and professional applications.

As used herein, the term “light field” at a fundamental level refers to a function describing the amount of light flowing in every direction through points in space, free of occlusions. Therefore, a light field represents radiance as a function of position and direction of light in free space. A light field can be synthetically generated through various rendering processes or may be captured from a light field camera or from an array of light field cameras. In a broad sense, the term “light field” can be understood and described as an array or subset of hogels.

As used herein, the term “hogel” refers to a holographic element or holographic pixel, which is a cluster of pixels with directional control. An array of hogels can generate a light field. As a pixel describes the spatial resolution of a two-dimensional display, a holographic pixel or hogel describes the spatial resolution of a three-dimensional display.

As used herein, the term “light field display” is a device which reconstructs a light field from a finite number of light field radiance samples input to the device. The radiance samples represent the color components red, green and blue (RGB). For reconstruction in a light field display, a light field can also be understood as a mapping from a four-dimensional space to a single RGB color. The four dimensions include the vertical and horizontal dimensions (x,y) of the display and two dimensions describing the directional components (u,v) of the light field. A light field is defined as the function:

LF:(x,y,u,v)→(r,g,b)

For a fixed point x_{f}, y_{f} in the light field, LF(x_{f}, y_{f}, u, v) represents a two-dimensional (2D) image referred to as an “elemental image”. The elemental image is a directional image of the light field from the fixed x_{f}, y_{f} position. When a plurality of elemental images are connected side by side, the resulting image is referred to as an “integral image”. The integral image can be understood as the entire light field required for the light field display. The parameters of a light field display can comprise one or more of: hogel pitch, pixel pitch, and focal length. The pixel pitch is defined as the distance from the center of one pixel to the center of the next.

It is contemplated that any embodiment of the compositions, devices, articles, methods, and uses disclosed herein can be implemented by one skilled in the art, as is, or by making such variations or equivalents without departing from the scope of the invention.

Described herein is a method for enhancing the quality of light field image in multi-view autostereoscopic displays, such as holographic displays, using light field pre-conditioning. The method uses a measurement of the display pixel behavior to inform image pre-processing to improve the light field output, which can also include sharpening and/or smoothing of tiled element transitions in a viewed image. Light field pre-conditioning comprises smoothing of transitions among optical elements and sharpening of the output light field based on the measured blurring kernel across a light field display. Variation in light distribution, or spread, from a particular pixel, which can also be thought of as blur, is a normal artifact of light field displays. Variances in luminosity and blur can be caused by hardware and natural variation in the structure of optical components. The brightness, or light intensity value, can be detected by a light sensor as the measured light intensity received from a light source. In a pixel array, light is received to a location in front of the display plane from a plurality of pixels such that the light from more than one pixel contributes to the luminosity or brightness received at the viewing location. In addition, any display with discrete optical components in which the beam shape of the light has a jump at transitions between components will have some visual discontinuity at these transitions. By determining the actual brightness received at a particular location relative to the display plane, the image can be adjusted to normalize the pixel brightness across the light field display to correct for variations in brightness and blur.

The presently described method detects discontinuities and variation in the resulting light field caused by the light emission hardware and applies a correction factor to the light field display to adjust the optical properties of the resulting light field to sharpen, smooth, and improve the image quality of the viewed images. By determining the actual brightness received at a particular location relative to the display plane, the image can be adjusted to normalize the pixel brightness across the light field display to correct for variations in brightness and blur. The present method can be used to improve the perception of any light field display with discrete components, including flat panel displays and projector-based displays and can increase perceived depth of projector-based displays as well as reduce and/or eliminate visual discontinuities at projector image boundaries.

Various features of the invention will become apparent from the following detailed description taken together with the illustrations in the Figures. The design factors, construction and use of the light field rendering technique(s) disclosed herein are described with reference to various examples representing embodiments which are not intended to limit the scope of the invention as described and claimed herein. The skilled technician in the field to which the invention pertains will appreciate that there may be other variations, examples and embodiments of the invention not disclosed herein that may be practiced according to the teachings of the present disclosure without departing from the scope of the invention.

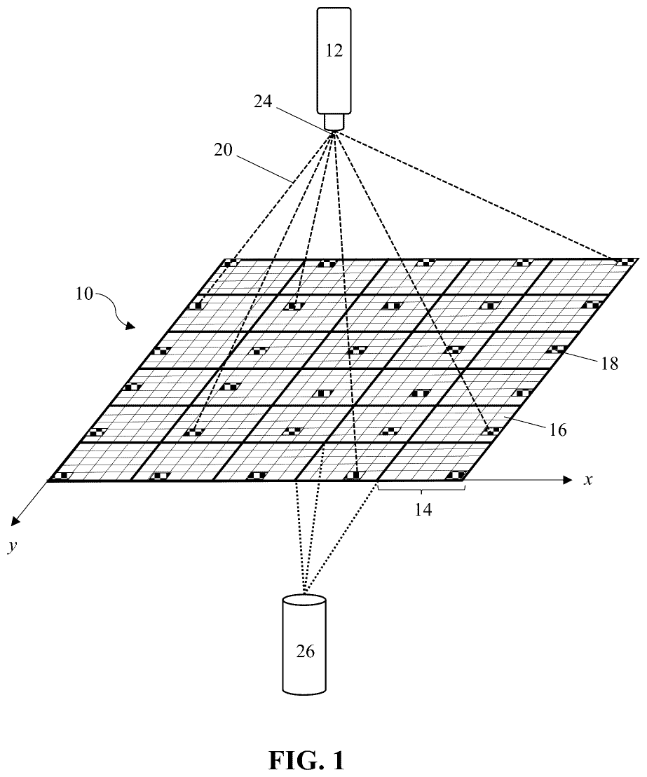

FIG. 1 illustrates a multi-view projector-based light field display with a display plane 10 comprising a plurality of hogels 14 arranged in an array in an x-y plane with a light sensor 12 at a reference position relative to the display plane 10. Each hogel 14 in the display plane 10 is comprised of a plurality of directional pixels 16, where each directional pixel 16 emits light at an angle to the display plane 10 along a directional ray 20. In a projector-based light field display, a plurality of projectors 26 emits and directs light at the light field display plane 10 to create a light field. A multi-view autostereoscopic display is capable of outputting multiple images simultaneously, with each image output to a different viewing angle, within a viewing angle range. Because the display plane 10 comprises an array of directional pixels 16, directional rays 20 can be directed at a wide angle spread relative to the display plane 10, enabling viewers to experience a 3D image at different viewing angles relative to the display. In addition, multiple views are generated by the autostereoscopic display at the same time, enabling a viewer to receive two different images at the same time, one to each eye, to create a holographic or 3D image.

Projector-based light field displays have an array of projectors 26 each having a series of optical components to generate a light field. To achieve the number of pixels to achieve a high-definition light field display, a large number of projectors are required, and optical alignment of the many images generated by the projectors is needed to create a smooth and high-quality light field display. Each projector generally comprises a plurality of light emitting diodes (LEDs), a projector body, and optical systems and components configured to cause a plurality of light rays generated by the light emitting diodes to create a multiplexed light field. In one example, a projector can have, in series, a light source such as a light emitting diode (LED), a projection component to receive light from the light source and direct the light into a single light ray path, a pixel forming component to receive and convert the light into a pixel array, a magnifying optical component to magnify the pixel array, a collimating optical component to collimate light from the pixel array and create a collimated projected image. Optical components in a multi-view projector system can include, but are not limited to, one or more liquid crystal on silicon (LCOS) panel, digital micromirror device (DMD), pixel forming device, plano-convex lens, dichroic mirror, lens array, microlens array, meniscus lens, bi-convex lens, single prism, folded prism, light field projection (LFP) lens, collimating lens array comprising a plurality of collimating lenslets, projection doublet, metasurface, and metalens.

Any light field display with discrete optical components in which the beam shape of the light has a jump at transitions between components will have some visual discontinuity at these transitions. Variations between the luminance of each light source, such as an LED in a projector or a subpixel in an OLED, as well as variability in the light directing optical components, both within each light field display and between optical components in a projector or OLED array, can cause observable differences optical measurements. Optical measurements include, but are not limited to, color, luminosity, size, luminance profile, and location of each projected image. The constraints of the hardware in each light field display can make physical adjustments difficult, however software adjustments based on hardware measurements of the light field display can apply a correction factor to control for the luminosity of each light source resulting in sharpening and smoothing of the projected image.

In a multi-hogel display plane, the blurring of individual pixels in the light field display can vary significantly across the display, and within individual projector or hogel regions, referred to herein as tiled optical elements. The same variable blurring can also occur in any display comprising an array of tiled optical elements, with sudden jumps in the light distribution between hogels. Accordingly, a single characterization can not be applied across the whole of the light field display since each pixel in the light field display can have a different luminance and luminance profile, or spread, for each color, across the display plane. Compared to a two-dimensional (2D) 4K display, which has 8 million pixels, a modern multi-view display has on the order of 100 million to 10 billion pixels, so even if every pixel could be uniquely characterized, the data storage and computation requirements to correct each pixel uniquely, would be untenable. Measuring one set of values for the whole display does not sufficiently capture the light emission range of each pixel, and it is also impractical to measure every pixel individually. However, it has been found that pixel grouping by hogel and measuring the luminance at a single canonical pixel in a hogel can provide sufficient luminance and spread data to precondition a light field to obtain significant and detectable sharpening and smoothing. The present light field pre-conditioning and smoothing procedure can specifically address sharp regional variations in a measured distribution to provide a smoothed image. By using complete per-hogel measured light distributions, the image can be sharpened more acutely than with averaged, or unspecified, image sharpening techniques. This process will reduce the perception of the transitions between separate optical elements in a light field display, helping to create a visually continuous light field. Moreover, the procedure addresses a previously unacknowledged alteration in the physical attributes of the light emitted by individual components of a light field display. The present method can provide a light field correction to the light field display by measuring the display light distribution around a directional canonical pixel for accurate input pre-conditioning to correct for the predicted light distribution defects and undesired variations. As the current approach does not depend on modeling and predicting the distribution of display light, it reduces the computational intensity needed for image pre-conditioning, making it especially efficient for tiled optical elements.

Conventional methods for measuring display light distribution typically involve measuring every pixel on the display. However, employing this approach for multi-view displays would be impractical due to their considerably larger number of pixels. Moreover, applying such methods to light field displays with an even greater number of pixels would pose even greater challenges. The method disclosed is suited to measuring displays having a heterogeneous, asymmetric light distribution due to uneven light distribution from each tiled optical element in the light field display. The present method allows for the measurement of a multi-view display light distribution without resorting to the measurement of all of the pixels in the display. As a result, the present method is less data intensive, while enabling a customized downstream input pre-conditioning to correct for defects, or undesired variations, in the display light distribution.

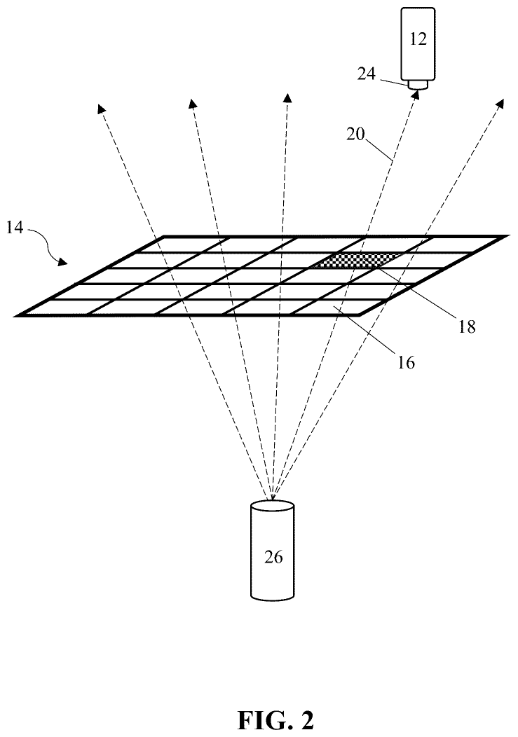

FIG. 2 illustrates a single hogel 14 in a projector-based display plane comprising multiple directional pixels. In a three-dimensional multi-view display device, the display plane will comprise a plurality of hogels 14 in an array, where each hogel 14 comprises a plurality of directional pixels 16, as shown, defined by axis x and y in each hogel 14. The display plane generally refers to the set of points and directions as defined by a planar display and the physical spacing of its individual light field hogel 14 and pixel 16 elements. Each pixel 16 in a hogel 14 has a specific light emission direction and emits light at an angle to the display plane along a directional light ray 20. In each hogel 14 the directional pixels 16 direct light to a viewer as a directional ray 20 at an angle relative to the display plane, and each hogel 14 will have a plurality of directional pixels 16 that direct light in a variety of different directions in order to provide the multiple-view images of an autostereoscopic display.

The directionality of the directional rays projected from different pixels in each hogel 14 creates the multi-view display, however all pixels 16 within the hogel 14 will rely on similar electronic and optical hardware, such as projector 26, and have been shown to have similar luminance profiles. As such, the measurement of the luminance profile of a single canonical pixel 18 in a hogel 14 can provide a representational correction factor to correct the blur and luminosity of all pixels 16 in the hogel 14. In a display system where pixels 16 in a hogel 14 have similar optical characteristics and output, using a per-hogel measurement of the angular distribution of light from a canonical pixel 18 the pixel input can be adjusted for each pixel in the hogel to bring the resulting display light field closer to the ideal light field, improving the display visual quality.

To measure the luminance profile at each canonical pixel 18, a light sensor 12 is aligned with the canonical pixel 18 such that the light from the canonical pixel 18 is the brightest pixel in the hogel 14 received at the sensor origin 24. The pixel in each hogel 14 which has its directional light ray 20 directly pointed at the sensor origin 24 on the light sensor 12 is referred to herein as the canonical pixel 18. To collect luminance measurements from the display plane, a light sensor 12 is positioned at a reference position in the viewing region above the display plane. By measuring the light intensity received by the light sensor 12 at sensor origin 24 from at least one canonical pixel 18 in each hogel 14 and creating a pixel luminance matrix (L) a pre-conditioning correction factor can be calculated for the hogel 14 in which the canonical pixel 18 is located.

Applying the correction factor prior to displaying the light field contributes to both the sharpening and smoothening of the image, improving the overall quality of the light field display. The pixel luminance matrix (L) describes the light contribution of multiple directional pixels to the light received at the sensor origin 24, and can be thought of as the shape of the light distribution received from the direction of the canonical pixel 18 as a contribution from many pixels in the pixel array, not only from the canonical pixel 18.

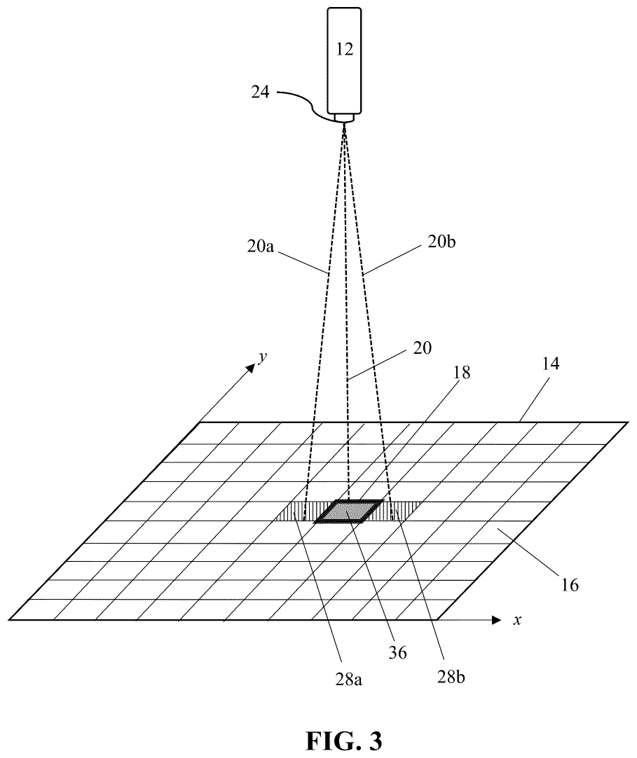

FIG. 3 illustrates the illumination of three directional pixels 16 in a hogel in a 1×3 linear pixel illumination pattern. A pixel illumination pattern has one or more lit pixels in a defined pattern. To calculate the contribution of each pixel in a hogel to the light received at a light sensor 12, the pixel illumination pattern can be projected at a plurality of locations on the hogel to create a pixel luminance matrix (L). The pixel illumination pattern can have any number neighboring pixels 28a, 28b surrounding an illumination pattern origin pixel 36, which in the case shown in FIG. 3 is the same as the canonical pixel 18, shown with a bold outline. A pixel pattern may have neighboring pixels at different locations in directions x and y relative to the origin pixel 36, and each of the origin pixel and neighboring pixel may have the same or different brightness or luminosity. Changing the location of the origin pixel 36 in the pixel illumination pattern relative to the canonical pixel in the x-y hogel matrix creates a pixel luminance matrix (L) which mathematically describes and approximates the light contribution of each pixel to the light received at the light sensor 12. The light sensor 12 is aligned with the directional ray 20 originating from canonical pixel 18. The canonical pixel 18 is the pixel whose directional ray 20 is the most aligned with the sensor origin 24 and appears to the light sensor 12 as the brightest pixel in the hogel 14. When canonical pixel 18 is lit as well as neighbouring pixels 28a, 28b, light sensor 12 receives light at the sensor origin 24 originating from all three pixels at once. Specifically, directional light ray 20 from canonical pixel 18 is received at the light sensor 12, but the light sensor 12 also received light from directional ray 20a originating from neighboring pixel 28a and directional ray 20b originating from neighboring pixel 28b. The light sensor 12 can be envisaged as a single eye at a location above the display plane that receives directional light from the pixel(s) in each hogel which is aimed directly at it. The light sensor 12 can be, for example, a single frequency light sensor, multi-frequency light sensor, photosensitive detector, or camera, optionally having one or more additional optical components for light shifting, lensing, collimating, or directing, including but not limited to a lens or mirror.

In an ideal light field display the directional rays 20, 20a, 20b from each pixel would be highly collimated, however due to blurring there is a non-zero light spread angle for each pixel, which results in the light of multiple pixels contributing to the image observed at an eye located at the sensor origin 24. To measure the actual luminance profile at each pixel in the display plane, the contribution of the light from the canonical pixel 18 and light-contributing surrounding pixels should be taken into account. To do this, the light field device displays the pixel illumination pattern and light is detected from the contribution of directional rays 20, 20a, 20b. The total light received by the light sensor 12 when the display device displays pixels in a particular illumination pattern provides an accurate indication of light received at the location of the light sensor 12 under the illumination pattern.

Precisely navigating a measurement apparatus across a display plane is feasible, but it presents significant challenges, requiring meticulous positioning and precise locational tracking due to its inherent complexity. In a light field display with microscale and nanoscale pixels and hogels, accurate positioning and re-positioning of a light sensor at a distance from the display plane can be extraordinarily challenging. To alleviate this complexity, the present method uses a fixed light sensor 12 and moves the digitally-controlled pixel illumination pattern on the light field display to sweep the light pattern across the light sensor 12 along either, or both, of the x and y axes. This allows for a fixed measurement apparatus in a rigid mechanical structure and fixed location of the display plane relative to the light sensor 12 to approximate the deviation in luminosity across a full light field display hogel. In particular, measurement of local blurring in the region around a canonical pixel 18 in a hogel can be used to approximate a blurring deviation throughout the hogel in which the canonical pixel 18 resides, allowing for sparse pixel measurements enhances the sharpening process for light field displays comprising millions to billions of pixels. Once this is achieved, a correction can be applied to pre-condition the light field to adjust the luminance at each pixel in the light field display to achieve a more uniform image.

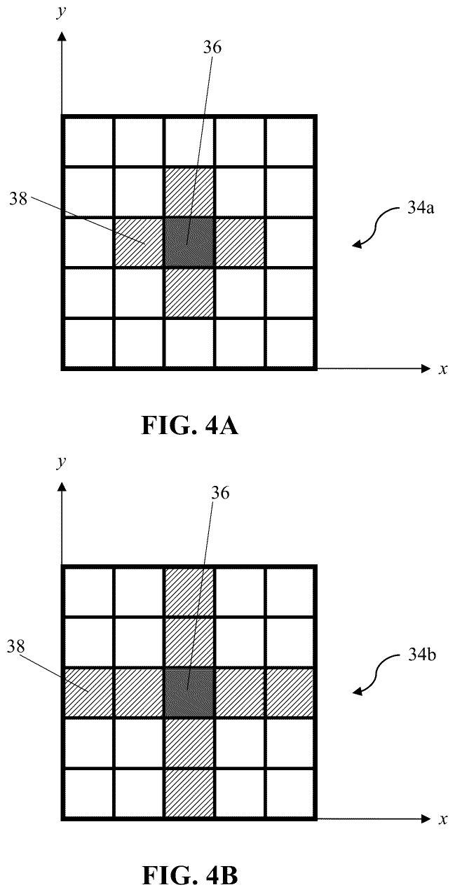

FIGS. 4A and 4B illustrate the utilization of two distinct pixel illumination patterns surrounding an origin pixel, leading to varying numbers of neighboring pixels along both the x and y axes. A pixel illumination pattern is a pattern of pixels that can be turned on in the display plane to measure how much light is received at a light sensor from the pixels in the illumination pattern at a given location in the display plane relative to the canonical pixel. FIG. 4A is one example of an illumination pattern and is a 3×3 cross pixel illumination pattern 34a around an origin pixel 36 with four neighboring pixels 38. FIG. 4B illustrates an example 5×5 cross pixel illumination pattern 34b with 8 neighboring pixels 38 arranged around an origin pixel 36. The pixel illumination pattern can occupy between a 1×1 and an nₓ×n_{y} pixel matrix, wherein n is between 1 and one less than the number of pixels in the hogel array. The pixel illumination pattern can have the same or different number of pixels in the x and y directions. Movement of the pixel illumination pattern around the canonical pixel in a light field display plane provides an approximation of the contribution of light received at a viewing location from the canonical pixel, as well as the pixels around it.

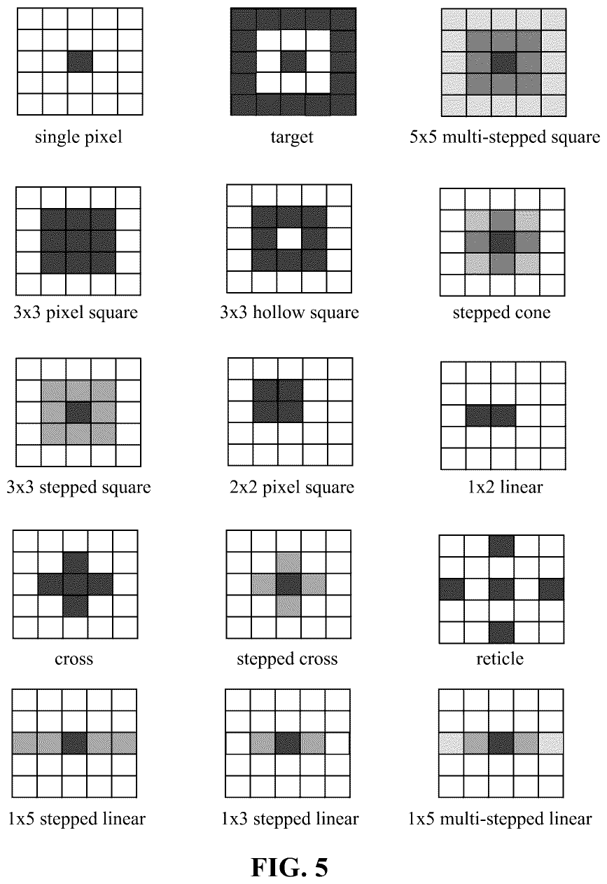

FIG. 5 illustrates different pixel illumination patterns resulting from various pixel placements in the x and y axes. Pixel illumination patterns can be based on the selection of certain pixels to be on or off, and the luminosity of each pixel in the pattern. Shown as ranging from fully off (white) to fully on (black), each pixel in a pixel illumination pattern can also have an intermediate luminosity (partly on) to provide the desired measurement. In an ideal case, a single pixel can be used in a pixel illumination pattern, however it has been found that using a more complex pixel illumination pattern provides improved accuracy in the resulting pixel luminance matrix L which provides better correction and pre-conditioning for the light field device. Squares, rectangles, and both symmetric and asymmetric patterns around the canonical pixel can be used for pixel illumination patterns. The pixels illuminated in a pixel illumination pattern can be, for example, centered around an origin pixel which is either lit or unlit, with lit neighboring pixels in the x-direction, neighboring pixels in the y-direction, lit diagonal pixels, and/or lit neighboring pixels of neighboring pixels. A single pixel can be used in the simplest pixel illumination pattern, which is an idealized case, however the light from a single pixel may not be sufficient to be accurately detected at the light sensor. Pixel illumination patterns with two or more pixels have been found to provide more light and be very useful in measuring light intensity and spread at a canonical pixel. In one example, a 3×3 pixel square which provides higher brightness than a single pixel, a pixel stepped square with a bright origin pixel and dimmer neighboring pixels, and a 2×2 pixel square. Cross shapes like solid and stepped crosses have been used, which produce different pixel luminance matrices L compared to squares. Linear patterns can also be used, including solid pixel lines and those with varying stepped luminosity across the line based on distance from an origin pixel. Although the present illustrated pixel illumination patterns are all 1×1 to 5×5 patterns, it is understood that larger pixel illumination patterns may also be used. Other patterns such as stepped squares, stepped crosses, reticles, and targets can have higher brightness while still having a single pixel at the origin with maximum pixel brightness at the origin pixel. Cone patterns and other patterns having highly stepped luminosity, meaning that the pixels in the pattern will be of varying brightness, can provide finer measurements, with dips between peaks providing a near-pixel profile luminance data for the display.

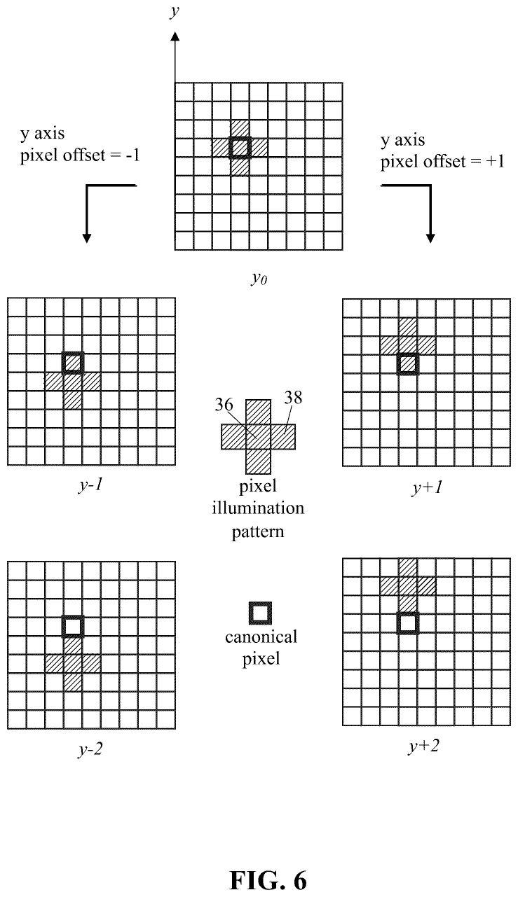

FIG. 6 illustrates the displacement of a 3×3 cross pixel illumination pattern around a canonical pixel in a hogel on a y-axis. To measure a luminance matrix for each hogel in a light field display, a light sensor is placed at a reference position at a distance from the display plane which is aligned with the canonical pixel. The light intensity value at a canonical pixel can be measured. The canonical pixel, highlighted in bold, refers to the pixel within a particular hogel that possesses the directional ray angle closest to that which would be received by the light sensor. The canonical pixel can also be understood as the brightest pixel in a hogel received at the light sensor in a defined location relative to the display plane, or the pixel with light of the highest brightness in any given hogel received at the light sensor. The canonical pixel selected for measurement can be used as a representative of the directional pixels surrounding it in the same hogel and the same, or similar, correction can be applied to all pixels in the hogel based on the measured pixel luminance at the canonical pixel. The pixel luminance matrix (L) of the canonical pixel, whose optical environment will be similar to that of pixels around it, can then be used to pre-condition and correct for illumination variances of the pixels in the same hogel.

The light intensity value measurement can be measured across a pixel offset range in a sweeping motion, shown in FIG. 6 along the y-axis. Luminosity at the canonical pixel with the pixel illumination pattern at y₀, y₋₁, y₋₂, y₊₁ and y₊₂ are shown, with the centre of the cross of the pixel illumination pattern, or origin pixel 36, being moved at the offset along the y-axis along with its neighboring pixels 38 in the pixel illumination pattern. The luminosity measurement at the canonical pixel is taken at the same reference position while executing the sweeping motion.

The light from each illuminated pixel in the pixel illumination pattern will have a light distribution that will overlap with the output of other neighboring pixels, and the contribution of all lit pixels in the pixel illumination pattern will contribute to the light received at the canonical pixel, even if the canonical pixel is not lit, as is the case in examples y₋₂ and y₊₂. This light distribution can lower the effective resolution, and therefore depth, of the resulting light field.

This per-pixel light distribution may also vary across the display. The present method can enhance the resolution and depth of the light field display closer to an ideal level by precomputing input pixel values. This involves utilizing information about the physical light distribution across pixels contributing to the detected luminance at discrete viewing locations, allowing for adjustments to those pixels to smooth and sharpen the overall received image. In addition, using light field pre-conditioning, the perception of transitions created by the boundaries between tiled optical elements, such as hogels, which impose varying light distribution, can be reduced, thereby improving the quality of the light field image and reducing tiling and undulating luminosity effects.

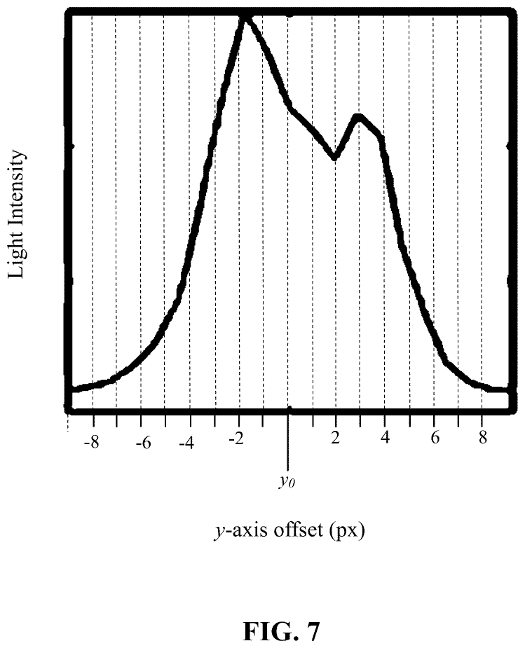

FIG. 7 is a graph of the luminance or brightness value data set for a single canonical pixel at location y₀ in a directional pixel array based on the incremental sweeping of a pixel illumination pattern from y₋₉ to y₊₉ across the pixel array. The light intensity is shown at y₀ when the origin pixel of the pixel illumination pattern is at the canonical pixel, and also offset in the y-axis from the canonical pixel from −9 to +9 on the y-axis. It is noticeable that the light intensity or luminance detected at the canonical pixel when the illumination pattern is centered at y-z is higher than when the illumination pattern is centered at y₀, which is unexpected but not uncommon. This sweeping measurement for a discrete canonical pixel of the light distribution pattern across an axis in the pixel array can be expressed as a pixel luminance matrix (L) which describes the light distribution or light blurring at a single canonical pixel.

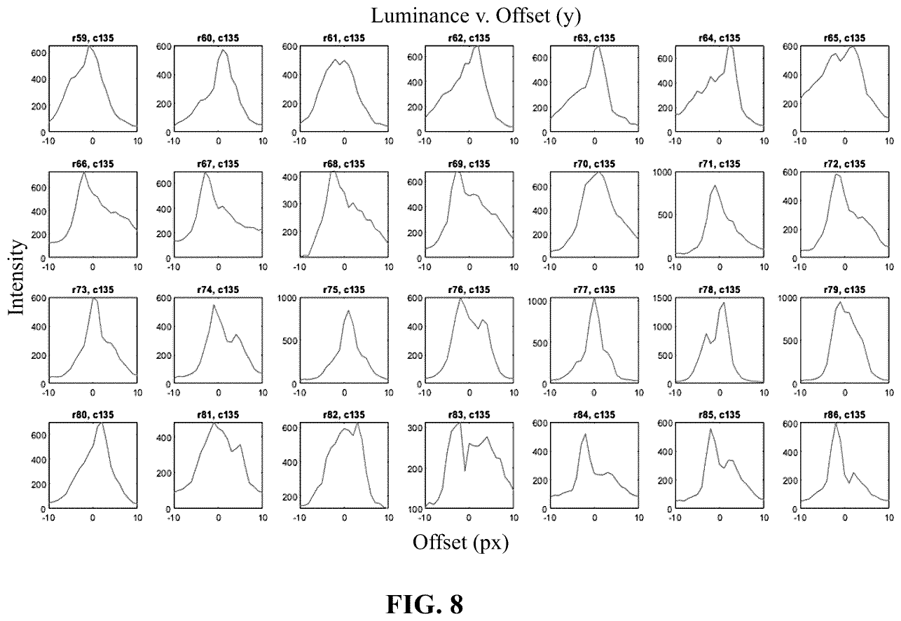

FIG. 8 illustrates graphical depictions of light intensity for a canonical pixel based on the distance of the origin of a pixel illumination pattern for a plurality of canonical pixels in a projector-based display plane. The luminance vs. offset graphs shown are one example of a 1D single axis (y) pixel luminance matrix (L) which describe the luminance contribution of light from pixels around the canonical pixel at origin 0 to the detected light at the light sensor. A similar 2D dual axis (x-y) pixel luminance matrix (L) can be used to represent the contribution of light to by pixels neighboring the canonical pixel in both the x and y directions on the pixel array. The luminance or brightness value (B) was measured for a plurality of pixels in a projector-based display plane in the green channel and is shown. The plots are labelled by hogel position (r<RowNumber>, c<ColumnNumber>) in the display plane and one canonical pixel is measured for each hogel. The asymmetry of peaks can be readily observed, as well as the sharp transitions at projector transitions, for example as shown in row 64 to row 66.

Light originating from each directional pixel in a light field display plane and received at an optical sensor can have wide and/or asymmetric distribution around the central luminance point. The distribution of light from each pixel can depend on, for example, the pixel location within the display plane, variances in the pixel microcavity (in an OLED display), variances in optical components, variances in electronic control systems within and between pixels and hogels, crosstalk or leakage within the pixel forming device, asymmetric optical paths in imaging optics, and diffraction through optical apertures. In addition, abrupt changes in light output can occur when transitioning between projectors or hogels which can cause tiling at the hogel boundary. Apart from content blurring away from the display plane, the dimming of certain projector boundaries in a projector-based display is visually apparent in the projected images and can be quantified using the current method. The pixel spread within a projector is a smooth function such that at any particular view, the light intensity “lost” from the intended pixel is “regained” from adjacent pixels. At the projector boundaries, there is reduced light distribution from neighboring pixels, which can create a discontinuity, resulting in certain views, originating from pixels at a hogel edge, to have a net loss of luminous intensity. This loss in luminosity at hogel edges can also be corrected using light field pre-conditioning at the pixel level with the present method. By measuring the light distribution at at least one canonical pixel in each hogel in the display plane, a correction can be applied to all pixels in a hogel to reduce the impact of this non-ideal light distribution by adjusting the input to the display. This builds from the assumption that neighboring pixels have similar blurring and enables approximation across a pixel array in a hogel. The result of the correction sharpens the resulting field to correct for wide light distribution and smoothes the transitions in light distribution to blend the distribution across projector boundaries. A customizable input signal with the applied correction to each pixel results in image sharpening and smoothing for the adjusted output image.

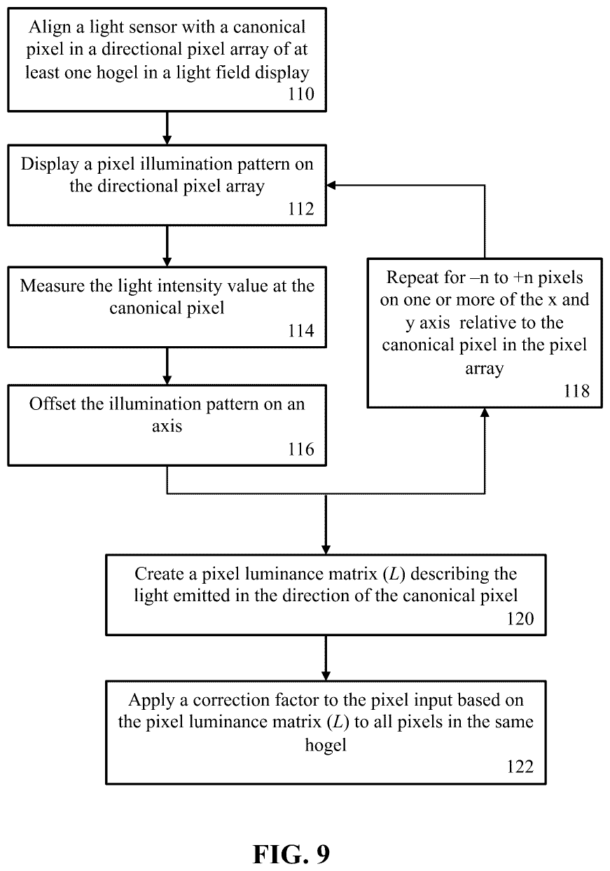

FIG. 9 is a flowchart illustrating a method of pixel input optimization for a light field display. In one example method, a light sensor is aligned with a canonical pixel in a directional pixel array of at least one hogel in a light field display 110. A pixel illumination pattern is then displayed on the directional pixel array 112 by providing instructions to the light field display to light the pixels in the display according to the pixel illumination pattern. The light intensity value at the canonical pixel is then measured with the illuminated pixel illumination pattern 114. The pixel illumination pattern is then offset on an axis 116, for example the x-axis or the y-axis. The process of displaying the pixel illumination pattern and measuring the light intensity at the canonical pixel is repeated for −n to +n pixels on one or more of the x and y axis relative to the canonical pixel in the pixel array 118. A pixel luminance matrix (L) is then created describing the light emitted in the direction of the canonical pixel 120 based on the luminance measurement as the pixel illumination pattern is displayed at various locations on the directional pixel array. The pixel luminance matrix (L) can be a one-dimensional matrix showing the luminance variation across a single axis or can be a two-dimensional matrix showing the luminance variation in both the x-axis and y-axis. The pixel luminance matrix (L) as measured at the canonical pixel can then be used to apply a correction factor to the pixel input to all pixels in the same hogel 122 to sharpen and smoothen the resulting image.

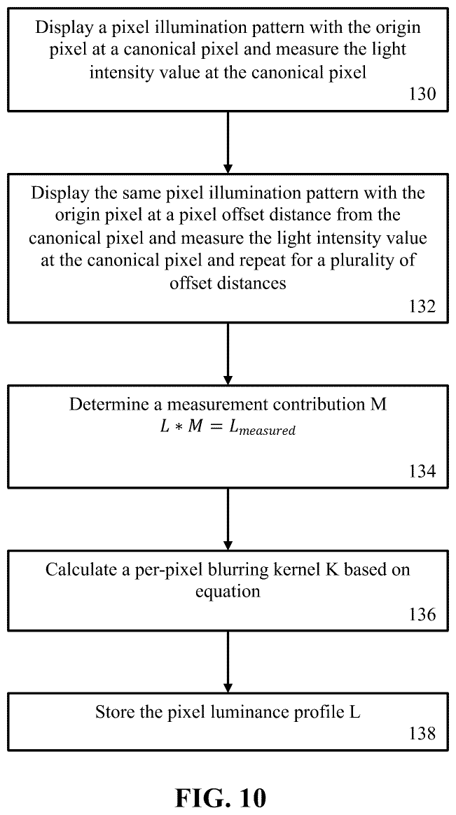

FIG. 10 is a flowchart illustrating a method of generating a pixel luminance profile by displaying and collecting luminance data of a pixel illumination pattern at a plurality of offset distances from the canonical pixel. First a pixel illumination pattern is displayed on a display plane with the origin pixel at a canonical pixel 130. The light intensity value is then measured at the canonical pixel. In another embodiment the pixel illumination pattern can begin at a different location on the display plane relative to the canonical pixel. The same pixel illumination pattern is then displayed on the display plane with the origin pixel at a pixel offset distance from the canonical pixel and the light intensity value at the canonical pixel is measured 132. This is then repeated for a plurality of offset distances relative to the canonical pixel and light intensity is measured at the canonical pixel. A measurement contribution M is then determined 134 based on the pixel luminance matrix generated centered at the canonical pixel and the luminance as measured according to:

$${L}_{px} \cdot M = {L}_{measure}$$

where:
Lₚₓ is the pixel luminance matrix
M is the measurement contribution and Lₘₑₐₛᵤᵣₑ is the as-measured luminance matrix.

A per-pixel blurring kernel K can then be calculated 136 and the pixel luminance profile L stored for the canonical pixel 138.

View Optimization with Peak Fitting

Light field projector display characterization by optical measurement and pixel input optimization was executed using peak fitting of luminance vs. offset measurements to identify the best match of pixel-to-viewer correspondence. The present display characterization and pixel input optimization reduces measurement noise sensitivity and allows for correct assignment in cases which the intensity profile differs significantly from a simple Gaussian function. All pixels in a hogel in a projector-based display will be subject to substantially the same conditions. Once the pixel luminance matrix is generated, it can be applied to all pixels in the same hogel.

Measurements obtained at a canonical pixel in a hogel provide offset data shifted in one of the x and y directions in small increments. Per-hogel luminance can be measured and stored as a function of the offset shift. The luminance vs shift data can be processed to determine an optimal peak position, for example using a luminance weighted average position or by fitting with luminance peak models. The optimal peak position can be used to update a pixel offset correction factor. The process can then be repeated for the other (x,y) direction. Further repetition can be performed to improve measurement signal and/or accuracy with different pixel illumination patterns or in different pixel offsets. Two-dimensional scans, which vary x and y over an area and process the 2D peak simultaneously can also be used. The light sensor may be moved in a defined way to collect additional peak measurements. One example pixel illumination profile for a single pixel illumination pattern can be used to increase the measurement signal s described by the luminance profile by:

$$V ( x , y ) = \{ ⌊ 191 \cdot {( 1 - \frac{r}{R} )}^{2} + 64 , ⌋ , r \leq R 0 , r > R$$

where:
V(x,y) is the sRGB value sent to the pixel,
r=max(x-xᵢ, y-yᵢ) is the is the Chebyshev distance from the center pixel at (xᵢ, yᵢ), and R is the configured pattern size.

Initial measurements of the example projector-based light field display contained three distinct peak types. The peak model attempts to fit each model type to the data and determines the best fit, and then assigns a peak position dependent on fit parameters and model type. Three peak formats selected for use were:

### Standard Gaussian:

$${Y}_{μ , σ , A} ( s ) = \frac{A}{\sqrt{2 π} σ} exp exp ( - {( \frac{s - μ}{\sqrt{2} σ} )}^{2} )$$

Double Gaussian with Equal Peak Shape:

$${Y}_{{μ}_{1} , {μ}_{2} , σ , A} ( s ) = \frac{A}{\sqrt{2 π} σ} ( ( - {( \frac{s - {μ}_{1}}{\sqrt{2} σ} )}^{2} ) + ( - {( \frac{s - {μ}_{2}}{\sqrt{2} σ} )}^{2} ) )$$

### Skewed Gaussian:

$${Y}_{μ , σ , α , A} ( s ) = \frac{A}{\sqrt{2 π} σ} ( - {( \frac{s - μ}{\sqrt{2} σ} )}^{2} ) ( 1 + erf ( α ( \frac{s - μ}{\sqrt{2} σ} ) ) )$$

where the peak position for each peak type is:
Standard gaussian: μ,
Double gaussian with equal peak shape: (μ₁+μ₂)/2
Skewed gaussian: peak maximum

To determine the hogel offset correction factor an initial array of hogel offsets was determined, where (kₓ, k_{y}) is the hogel index, k_{c} is the color index (R/G/B), and k_{d} is the direction of the offset (x,y). For each direction, d∈{x, y}, and each color, c∈{R, G, B}first the offset shift, s, from −N to +N relative to the canonical pixel was done by:
a) generating an image as a pixel illumination pattern with the center pixel shifted by s:

$$( x , y ) = S ( {k}_{x} , {k}_{y} , {k}_{c} , {k}_{d} ) + sT ( {k}_{c} , {k}_{d} )$$

where S(kₓ, k_{y}, k_{c}, k_{d}) is the initial estimated offset correction factor, and the transformation only applies s to the dimension under test, i.e.:

$$T ( k\_c , k\_d ) = \{ 1 , if {k}_{c} = c and {k}_{d} = d 0 , otherwise$$

b) sending the generated image of the pixel illumination pattern to the display under test,
c) capturing the camera image of the displayed pixel illumination pattern at the canonical pixel,
d) determining the per-hogel luminance from the captured image at the canonical pixel, and
e) storing the luminance for the offset shift:

Y(kₓ,k_{y},k_{c},k_{d},s)

For each hogel (kₓ, k_{y}), and color/direction c and d, Y(kₓ, k_{y}, k_{c}, k_{d}, s) can then be fit as a function of s using the luminance peak model above, returning the peak position P(kₓ, k_{y}, k_{c}, k_{d}). The offset array can then be updated S (kₓ, k_{y}, c, d)=P(kₓ, k_{y}, k_{c}, k_{d}). If desired, multiple iterations can be performed. It has been observed that with each iteration, the offset assignment improves so that the measurement in step (d) above will increase in brightness. After adjusting the hogel offsets using this procedure, the angular distribution of each pixel in the display can be estimated using a similar process. The pixel luminance profile is narrowed and the determination can be repeated for both x and y directions without the offset adjustment update. The pixel spread at the canonical pixel can then estimated as the reverse of the pixel offset luminance profile, and saved as a per-hogel pixel spread function. In this method of measuring luminance vs. offset for a particular canonical directional pixel, a display correction can be applied that corrects for the angular distribution of the light emitted at that pixel. Applying a display correction to the pixel input, the displayed image can be sharpened and smoothed and results in an increase perceived depth and reduced discontinuities at projector or pixel edges. Using a per-hogel measurement of the angular distribution of light from a canonical pixel and applying the calculated correction factor to input pixels in the light field display reduces the perception of transitions created by the switch between optical elements by blending the transition between discrete optical components by adjusting the input image to artificially match the angular light distribution of adjacent pixels.

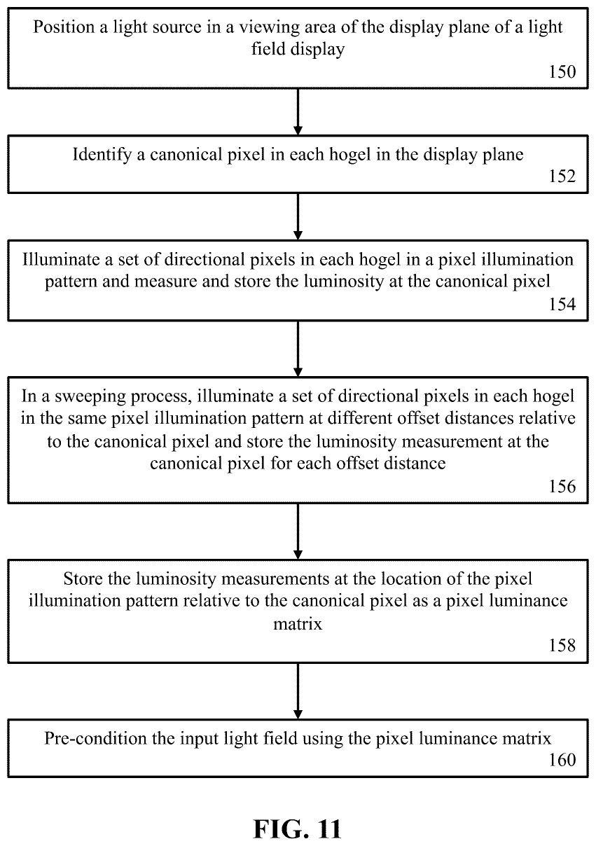

FIG. 11 is a flowchart illustrating a method of characterization by optical measurement and pixel input optimization for a whole light field projector display. The method for determining and applying a correction for a single hogel in a light field display can be applied simultaneously at multiple hogels in the display at the same time. This approach enables the simultaneous measurement of multiple pixels located at various distant positions, as there is minimal, if any, interference from light. To begin the measurement, a light sensor is positioned at a distance from and in the viewing area of the display plane of a light field display 150. Measurements are then performed by the light sensor in the fixed location and at a fixed distance relative to the display plane and in the viewing zone of the display. The measurement initiates with an identification of which pixel or pixels in each hogel in the display plane are most directly pointed at the light sensor 152, referred to herein as the canonical pixel in each hogel. As each hogel in the light field display comprises a plurality of directional pixels, the location of the light sensor will generally have one pixel that is brightest in each hogel, which is the directional pixel where the directional ray from the pixel is most aligned with and received by the optical sensor. The brightest directional pixel in each hogel is defined as the canonical pixel for each hogel at the fixed position of the light sensor relative to the display plane. As is evident, if the light sensor is placed at a different location (x,y) relative to the display plane, a different directional pixel in each hogel will be identified as the canonical pixel for that light source location. The set of canonical pixels in the light field display, one for each hogel, is then selected as the origin for the illumination measurements.

To measure light distribution for the entirety of a light field display, a pixel illumination pattern is selected for the investigation and a small group of directional pixels in each hogel are illuminated in the pixel illumination pixel pattern in an otherwise black display 154. Generally, the first location for display of the pixel illumination pattern on each hogel will be such that the pixel illumination pattern is centered, or has an origin pixel, on either the y-axis or the x-axis of the canonical pixel in the same hogel. Upon illumination of the pixel illumination pattern, the light output at the canonical pixel is then measured at the light sensor or camera which is positioned above the display plane and aimed at the display and the brightness or luminosity measurement stored 154. In a sweeping process, which is how the method looks to an observer, the illuminated pixels are moved around each hogel in the display while the light sensor monitors the brightness or luminosity at the canonical pixel in each hogel 156 and stores the luminosity measurement for each location as a pixel luminance matrix centred on the canonical pixel 158. In either, or both, of each direction (x,y) and for one or more pixel color (R,G,B) in the display plane, the light received by the light sensor is recorded relative to the offset distance of the origin pixel in the pixel illumination pattern to the canonical pixel. A luminance or light intensity graph centered on the canonical pixel in each hogel is collected.

In an RGB color light field display, the light field input has three color channels and a color specific correction factor can be calculated independently for each color channel. The three correction factors can then be combined into a single input light field input for pre-conditioning the light field. In a two color light field display a correction factor can be determined for each of the two color channels. To determine the correction factor for each color channel the light sensor used can be color sensitive or not color sensitive. For a light sensor that detects luminosity only and not color, each color channel can be detected independently. In a color sensitive sensor, color filters may be used such that multiple color channels can be measured at once.

The input light field can then be adjusted using the pixel luminance matrix in a sharpening step compatible with spatially varying blurring for pre-conditioning 160, as herein described. Sharpening and smoothing steps based on the per-pixel light distribution in each hogel can also be utilized to identify an achievable target output distribution for adjustment of the input light field. A deconvolution algorithm can also be used to solve for the artificial blurring to reduce the blurring. In this way, light field smoothing can address sharp regional variations in a measured distribution providing a smoother light field display image with less tiling to create a more visually continuous light field.

### Sharpening and Smoothing

In an idealized light field display, the light from an individual pixel is output as a narrow symmetric beam around its chief ray direction. The current display characterization and correction adjusts for misalignment of the pixel to the chief ray direction. However, the light distribution from any pixel can have wide and/or asymmetric distribution around the ideal central luminance point. The optical design constraints on a light field display can result in loss of contrast between neighboring pixels and blurring of the output image. Most of the optical blurring is unchanging after assembly of the light field display device with its hardware constraints, however full control of the data sent to the individual pixels can be exercised to pre-process the content to create an output light field that is closer to the ideal output (i.e., with less blurring). The distribution of light in a light field can also depend on the pixel location within the display, with abrupt changes occurring when transitioning between projectors. The correction described herein seeks to reduce the impact of this non-ideal light distribution by adjusting the input to the light field display to sharpen the resulting light field image to correct for wide light distribution and to smooth the transitions in light distribution to blend the distribution across a projector boundary. Preferably, a smoothing adjustment is carried out prior to sharpening to make use of the combined real and software kernel such that the physical blurring can be replaced with a combined physical blurring and software smoothing in a sharpening step. The result should be a smooth kernel, but sharper overall image. It is noted that sharpening can be done prior to smoothing in some instances. An image sharpening process and a smoothing process can also be combined simultaneously to enhance image depth and smooth projector transitions. This requires solving for both a smoothing and sharpening kernel that produces the combined kernel that has acceptable smoothness and minimal spread.

### Sharpening

The goal of sharpening is to make the output light field closer to the idealized light field LF_{target}. In a sharpening method, the luminosity data collected for each hogel using the present method can be processed as a pixel luminance matrix using custom computation, peak fitting, and data processing. A blurring kernel, which mathematically describes the pixel spread, can then be applied to each hogel depending on the pixel luminance matrix. Since pixels in different regions, and different hogels, of the display plane can have significantly differing pixel luminance matrixes, the blurring kernel will also vary significantly across the display. A sharpening implementation as described herein allows for regional correction and application to the pixel input of a varying blurring kernel based on the location of each pixel in the light field display. A complete per-hogel measurement enables more acute sharpening and a custom solution that is local to each hogel. In contrast to averaging image sharpening methods, the current approach has shown to diminish the perception of transitions between distinct optical elements and deliver a smoother, more continuous light field. Consequently, it addresses an overlooked alteration in the physical properties of the light emitted by discrete elements in a light field display.

The present sharpening method can be variably applied across a light field display on a per hogel basis. In one example the sharpening method can use an iterative correction algorithm wherein an initial input is updated for each iteration k by the difference between the ideal light field and the simulated display output L·LFₖ for from the current step input LFₖ. The first step input is the ideal light field made up of narrow rays around the chief ray, LF_{target}, each iteration k can follow the following formula:

$${LF}_{k + 1} = {LF}_{k} + λ ( {LF}_{target} - L \cdot {LF}_{k} ) ,$$

where:
LFₖ is a current step's input light field
LFₖ₊₁ is a resulting light field, used as input to the next iteration,
λ is a scaling parameter and variable parameter between different iterations,
L is the pixel luminance matrix, which is a measure of pixel spread, also referred to as the pixel blur
L·LFₖ is the convolution of L and LFₖ, and
LF_{target} is the ideal light field output, initially used as input.

This sharpening protocol can be repeated to the desired number of iterations to achieve the sought-after sharpness for the image. In an iterative process, the first sharpened light field LF₁ is set to approximate the target LF₁=LF_{target}. The sharpened light field can then be iteratively adjusted over k steps by first calculating the expected physical output field, which is the convolution of the pixel blur and the input field K·LFₖ. The convolution is then calculated for each pixel region group, in this case for each hogel in the display plane, such that the value of K·LFₖ for each hogel (a,b) in the display plane is calculated using the pixel blur for that hogel K_{(a,b)}, and the light field section in that hogel. The total output K·LFₖ is the combination of all K_{(a,b)} LF_{k(a,b)} for the display plane.

The input light field can then be updated for the next step using the difference between this steps output field and the target according to the sharpening equation LFₖ₊₁=LFₖ+λ(LF_{target}−K·LFₖ), above. The value of lambda can then be set to speed convergence of the solution without oscillating the output. Specifically, the lambda value can vary across different iteration levels. For instance, it may initially be set high to approximate the ideal light field and later adjusted downward for more precise sharpening correction. In one example, the value of lambda λ can be dynamically adjusted as an option to expedite convergence. The final sharpened light field is the field calculated in the last iteration step:

$${LF}_{sharp} = {LF}_{C + 1}$$

where:
LFₛₕₐᵣₚ is sharpened light field output by the sharpening process, and
LF_{C+1} is the resulting light field as calculated by iteration C of the above process.

The target light field can have any content, including a wide range of frequencies and contrast levels. Accordingly, the sharpening algorithm should be general enough to accommodate a wide variety of colors and luminosities. As an alternative sharpening method, the equation L·LFᵢₙ=LF_{target} can be solved via a deconvolution algorithm to extract a LFᵢₙ. There exist numerous algorithms for comparable deconvolutions, although they typically do not accommodate variations in L across the light field. The presence of a spatially varying kernel L is uncommon in other display systems, as regional differences are generally absent in the display plane of two-dimensional display systems that rely on a fixed kernel measurement for sharpening. In an autostereoscopic display the form of the kernel can change dramatically over the display, not only in luminosity, but also luminosity profile, with highly symmetric peaks in some hogels to very asymmetric and double peaks in other hogels. This vast difference in luminosity pattern precludes a parameterization of the kernel across the whole of a light field display. The present solution provides measurement of luminosity as well as luminosity pattern for every hogel in a display plane, which can then be used to apply a kernel specific for each hogel to every pixel in the display.

Measurement of the sharpening kernel for each discrete region in a hogel-based light field display and application of the light field input correction on a regional basis for each hogel can provide a tailored sharpening solution specific to each region in the display plane based on the pixel illumination at each hogel region. This iterative sharpening technique excels in identifying locally optimized kernels for areas with substantial contrast variations and unrestricted input light fields, resulting in a highly sharpened field with pixel input.

### Smoothing

The tiled optical elements in a light field display, such as hogels or projectors, introduce a sudden jump in the physical blurring (K) at boundary regions, where one tiled optical element ends another one begins. The sudden increase in blurring leads to visual artifacts, which are perceived as discontinuities in 3D displayed content, such as abrupt changes in overall brightness along boundary edges. These anomalies may also manifest as gaps, or overlaps, between tiled optical elements. Due to the discrete nature of these transitions and the considerable separation between hogels in a light field, determining what constitutes a “smooth enough” output image is not straightforward. That is, the “smoothness” criteria, which include, for example, a foveal range, that are applicable to 2D display properties do not necessarily translate to a holographic or stereoscopic light field displays. The directional pixels in each tiled optical element are subject to local conditions that change the luminosity and luminosity profile for each pixel in the tiled optical element. Because each tiled optical element displays different local behavior, a smoothing procedure must be considered locally for each tiled optical element over the subset of pixels in that element.

The fundamental concept behind smoothing is to ensure that the physical output field, LFₒᵤₜ does not exhibit abrupt changes in output intensity at any point. This is a problem where the blurring kernel K changes in the physical system, such as between hogels. The input field can be adjusted to hide the sudden transition in K thus smoothing the light field image. To reduce the discontinuity created at the projector boundaries by the changing pixel spread, the input can be adjusted to artificially add distribution to pixels to create a continuous blurring across the projector transition. The target image is such that that the display output has a smooth effective blurring at the projector edges.

A software blurring kernel, G, can be found and then applied to the pixel input to smooth the image in the boundary region of any projector or hogel boundaries where sharp L transitions are expected. The characterization procedure determines the applied software blurring kernel, G, so that the combined convolution of physical and software applied blurring L·G, is smooth. A smoothing method can thereby be applied to the correction factor involving the application of an artificial distribution to a plurality of pixels in a hogel. The artificial distribution can be applied through the software blurring kernel G using the pixel luminance matrix L to the input image before sending it to the light field display such that the image sent to the display is (G·LFᵢₙ), and the image emitted by the display is:

L·(G·LFᵢₙ)

where:
L is the measured display the pixel luminance matrix (L) as representative of pixel spread,
G is the derived smoothing kernel, and
LFᵢₙ is the original unconditioned input light field.

An illustrative instance of this implementation involves estimating an attainable smooth target kernel, denoted as H, based on the measured display kernel K. This estimation is performed individually for each hogel or pixel, depending on the processing layer. Here, H is computed as a weighted average of the surrounding measured kernels. When the average is taken only along the direction of the kernel, a 1-D average takes the form of:

$${H}_{k} = {\sum }_{j = k - m}^{k + m} {w}_{j - k + m} {K}_{j}$$

One example of possible weights is:

$$\underline{w} = [ 1 , 1 , 2 , 2 , 2 , - 4 , 2 , 2 , 2 , 1 , 1 ]$$

Note the negative weight for the central hogel so that has a negative dependence on H_{x,y}.

To determine the required software blurring kernel G, the convolution equation K·G=H can be solved, for example, by the Richardson-Lucy algorithm for deconvolution. For each hogel index k, the software kernel can be determined that best reproduces the Hₖ kernel when the pixel blurring for that hogel, Kₖ is applied afterwards. This smoothing implementation results in reduction of visual artifacts generated by tiling optical components at boundary regions, creating a more apparently continuous light field output.

When the light in a single hogel is originating from more than one tiled optical element, the smoothing pre-treatment can be applied to pixels within the hogel to smoothen the light field image. In one example, for hogel Q, a camera or light sensor at a particular location relative to the display plane primarily sees a particular pixel N. Pixel N is referred to as the canonical pixel in the determination method as set out above. If pixel N passes through optical element A, then all of the pixels within the hogel Q that also pass through optical element A can use the measured kernel for that hogel, K_{A(Q)}. However, for the pixels in Q that come from optical element B, the measured kernel K_{A(Q)} is not used and instead the Kernel for those pixels is extrapolated from the kernel of nearby hogels that do measure element B directly.

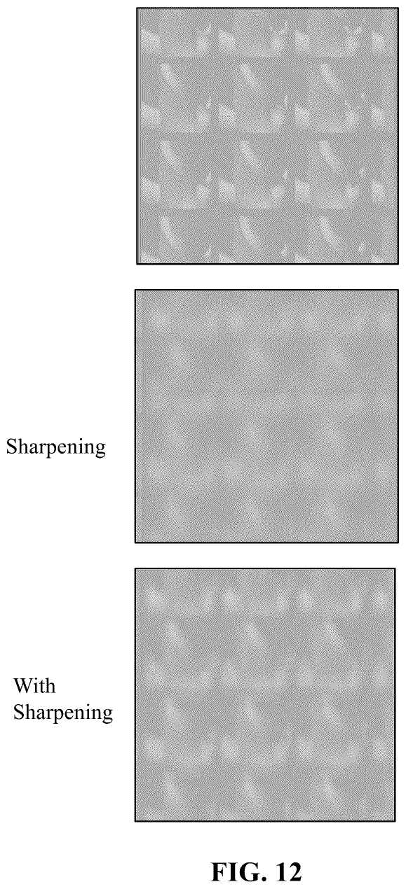

FIG. 12 illustrates a subsection of a light field before and after sharpening, juxtaposed with an ideal light field output. The light field was processed with an example blurring kernel K=2000, with λ=0.006 gradually decreasing to 5×10⁻⁴. As evident by the post-sharpening image, the sharpening method was able to reduce the image degradation due to blurring, recovering some of the overall brightness and sharper features, compared to the untreated image.

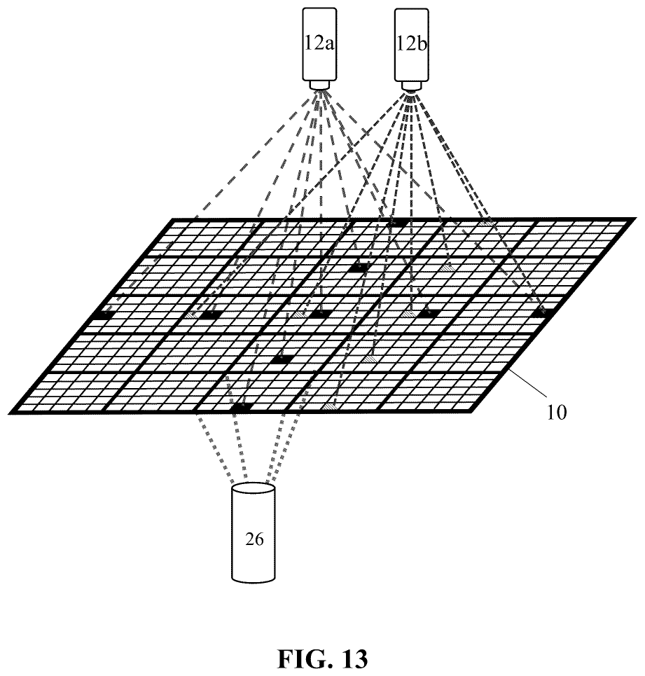

FIG. 13 illustrates a setup for measuring a projector-based multi-view display, featuring a (x,y) display plane 10 and two light sensors 12a, 12b positioned at distinct reference points relative to the display plane 10. Light emitted from various pixels within the display plane can be captured by light sensors 12a, 12b. These sensors detect light at different sets of canonical pixels within each hogel on the display plane, which are projected from projector 26. The light intensity of different pixels is measured accordingly. Such a measurement could be used to either improve accuracy of per-hogel measurements, or to measure and pre-condition at a finer resolution than per-hogel. As an example, four light sensors placed in distinct quadrants of the display viewing plane could provide per-quarter-hogel correction, if necessary.

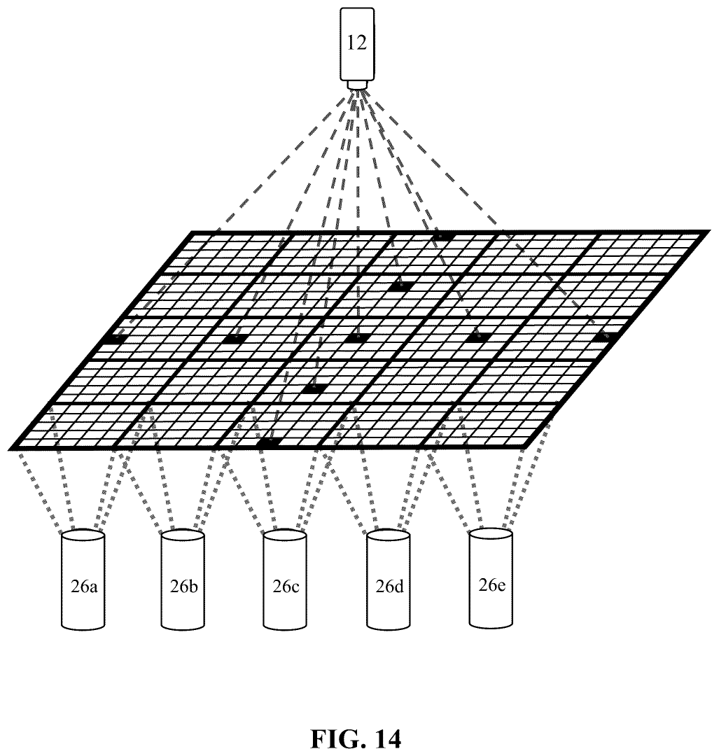

FIG. 14 illustrates a projector-based multi-view display having tiled optical elements configured to provide light to each pixel in each hogel of the multi-view display. Projectors 26a-26e project light to create the display plane 10, which can be detected at light sensor 12.

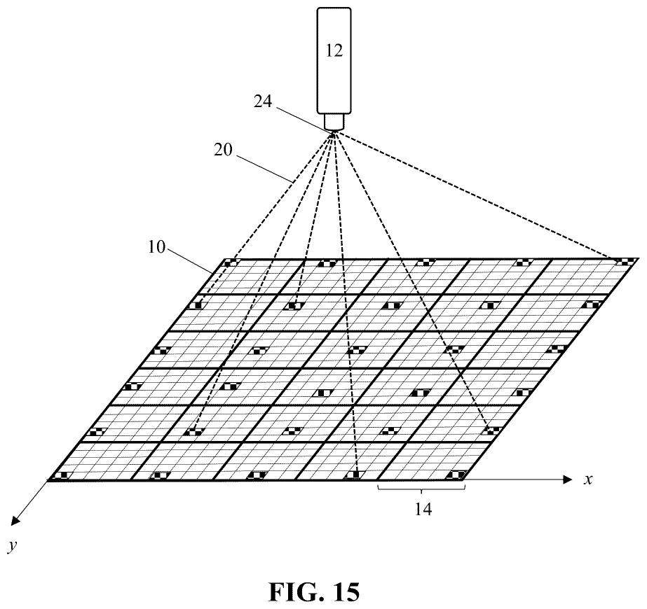

FIG. 15 illustrates a multi-view (x,y) flat panel based display plane 10 in a plane with a light sensor at a reference position. In the case of a flat panel display, display plane 10 is created from a pixel array of light sources, such as LEDs, OLEDs, etc., arranged in a plurality of hogels. The directional pixels 16 in each hogel have directional rays 20 which emit light at various angles to the display plane 10, creating a stereoscopic display. In the present method, a light sensor 12 positioned at a location from the display plane 10 will receive light at sensor origin 24 from directional rays 20 coming from pixel sources in the display plane 10.

All publications, patents and patent applications mentioned in this specification are indicative of the level of skill of those skilled in the art to which this invention pertains and are herein incorporated by reference. The reference to any prior art in this specification is not, and should not be taken as, an acknowledgement or any form of suggestion that such prior art forms part of the common general knowledge.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A pre-conditioning method for an input light field comprising:
positioning a light sensor to receive light from a hogel in a light field display plane;
displaying a pixel illumination pattern centered at a first pixel location in the hogel on the light field display plane;
measuring a light intensity value at a canonical pixel in the hogel with the light sensor;
displaying the pixel illumination pattern at an offset position relative to the first pixel location on the light field display plane;
measuring the light intensity value at the canonical pixel when the pixel illumination pattern is at the offset position;
generating a luminance profile for the canonical pixel based on the light received by the light sensor at the canonical pixel; and
calculating a correction factor for the canonical pixel.

2. The method of claim 1, further comprising displaying the pixel illumination pattern at a plurality of offset positions relative to the first pixel location and measuring the light intensity value at the canonical pixel at each of the plurality of offset positions.

3. The method of claim 1, further comprising applying the correction factor to an input light field for at least one pixel in the hogel.

4. The method of claim 3, further comprising recalculating the correction factor for each of a plurality of input light fields.

5. The method of claim 3, further comprising applying the correction factor to the input light field for all pixels in the hogel.

6. The method of claim 3, wherein the correction factor adjusts the luminosity for at least one pixel in the hogel.

7. The method of claim 1, wherein the pixel illumination pattern is a single pixel, linear, stepped linear, square, stepped square, rectangle, cross, stepped cross, reticle, or target.

8. The method of claim 1, wherein the light intensity value at the canonical pixel is measured at multiple color channels.

9. The method of claim 8, wherein the correction factor is calculated for each color channel.

10. The method of claim 8, wherein the correction factor for each color channel is combined and applied to the input light field.

11. The method of claim 1, wherein the offset position relative to the first pixel location is along one or both of the x and y axis of the hogel.

12. The method of claim 1, further comprising calculating a per-pixel blurring kernel based on the luminance profile.

13. The method of claim 1, wherein the light field display plane is created by a light field display comprising a directional pixel array in a projector-based light field display or a flat panel light field display.

14. The method of claim 13, wherein the flat panel display is one of a LED, OLED, LCD, or MicroLED display.

15. The method of claim 1, wherein calculating a correction factor results in one or more of sharpening the light field and smoothing the light field.

16. The method of claim 1, wherein the light sensor measures the light intensity from more than one hogel in the light field display plane.

17. The method of claim 1, wherein the light intensity value measured at the light sensor measures multiple color channels at the same time.

18. The method of claim 17, further comprising:
positioning an additional light sensor to receive light from an additional canonical pixel in the hogel in a light field display plane;
displaying a pixel illumination pattern centered at an additional pixel location in the hogel on the light field display plane;
measuring a light intensity value at an additional canonical pixel in the hogel with the light sensor;
displaying the pixel illumination pattern at an additional offset position relative to the additional pixel location on the light field display plane;
measuring the light intensity value at the additional canonical pixel when the pixel illumination pattern is at the additional offset position; and
generating a luminance profile for the additional canonical pixel based on the light received by the additional light sensor at the additional canonical pixel.

19. The method of claim 18, wherein calculating the correction factor comprises incorporating into the correction factor an additional correction factor for the additional canonical pixel.

20. A system for pre-conditioning a light field display comprising:
a light sensor for measuring a light intensity value in the direction from a canonical pixel in a hogel in a display plane of a light field display;
a frame for supporting the light sensor in front of the display plane; and
a processor configured to perform the method of:
displaying a pixel illumination pattern centered at a first pixel location in the hogel on the display plane;
displaying the pixel illumination pattern at an offset position relative to the first pixel location on the display plane;
generating a luminance profile from the light intensity values measured by the light sensor for the canonical pixel at the first pixel location and the offset position, the luminance profile describing the light received from the direction of the canonical pixel to the light source from the display plane.

21. The system of claim 19, wherein the processor calculates a correction factor for the canonical pixel.

22. The system of claim 19, wherein the light field display comprises a directional pixel array in a projector-based light field display or a flat panel light field display.

23. The system of claim 22, wherein the the flat panel display is one of a LED, OLED, LCD, or MicroLED display.

24. The system of claim 20, wherein the processor is further configured to perform the steps of:
calculating a correction factor for the canonical pixel;
applying the correction factor to an input light field to generate a corrected light field; and
displaying the corrected light field on the light field display.

25. The system of claim 20, wherein the light sensor is a single frequency light sensor, multi-frequency light sensor, photosensitive detector, charged coupled device (CCD), liquid crystal on silica (LCOS) sensor, or camera.

26. The system of claim 20, wherein the light sensor comprises one or more additional optical components for light shifting, lensing, collimating, or directing light.

27. The system of claim 20, wherein the offset position relative to the first pixel location is along one or both of the x and y axis of the hogel.

28. The system of claim 20, wherein the system comprises more than one light sensor.
